(19) United States
(12) Patent Application Publication
(10) Pub. No.: US 2007/0085237 A1
(43) Pub. Date: Apr. 19, 2007

(54) Resin sealing and molding method of electronic component

(75) Inventor: Yohei Onishi, Kyoto-shi (JP)

Correspondence Address: BIRCH STEWART KOLASCH & BIRCH, PO BOX 747, FALLS CHURCH, VA, 22040-0747, US

(73) Assignee: TOWA CORPORATION

(21) Appl. No.: 11/543,778

(22) Filed: Oct. 6, 2006

(30) Foreign Application Priority Data
Oct. 13, 2005 (JP) 2005-298262

(51) Int. Cl. B29C 45/14

(52) U.S. Cl. 264/272.11

(57) ABSTRACT

In a resin sealing and molding method of an electronic component, a mold assembly of a three-piece structure of upper, intermediate and lower molds, and a mold release film are used. When the mold release film covers a cavity surface, it is forcibly attracted toward a lower mold cavity surface. Thus, the entire surface of the cavity, including a cavity surface formed of cavity side surface, cavity partition surface and communication path surface, in addition to the lower mold cavity surface, is covered with the mold release film applied with tension. Molten resin within the cavity is distributed uniformly into blocks constituting the cavity, via a communication path, and the electronic component in each block is sealed and molded while being completely immersed in the molten resin. This ensures close contact of the mold release film with the cavity along its shape, and prevents warpage of the finished, sealed substrate.

This nonprovisional application is based on Japanese Patent Application No. 2005-298262 filed with the Japan Patent Office on Oct. 13, 2005, the entire contents of which are hereby incorporated by reference.

### BACKGROUND OF THE INVENTION

1. Field of the Invention

The present invention relates to improvement in a resin sealing and molding method of an electronic component in which an electronic component mounted on a matrix-type substrate is sealed with resin using a mold assembly for resin sealing and molding and a mold release film.

2. Description of the Background Art

There is a method of sealing an electronic component mounted on a matrix-type substrate with resin which uses a mold assembly for resin sealing that is made of two pieces as well as a mold release film (see, e.g., Japanese Patent Laying-Open No. 2002-036270 (page 4, FIG. 8)).

The mold assembly disclosed in Japanese Patent Laying-Open No. 2002-036270 is characterized in that a plurality of cavities are formed corresponding to respective chips, and that a runner portion is formed between the cavities for adjusting the amount of resin. The mold assembly is further characterized in that a mold release film is used for improving releasing efficiency of the sealed substrate, and that the mold release film is applied to a mold surface of a lower mold including the cavities and the runner portion. According to this method, the chips can be molded efficiently, since cavities are formed independently for the chips.

When the above-described resin sealing method is used, however, it becomes difficult to maintain close contact of the mold release film with the mold surfaces of the cavities, as the number of chips on the matrix-type substrate increases and the chips themselves become thinner and smaller.

Further, according to this conventional mold assembly, it would be very difficult to bring the mold release film into close contact with the runner portion formed between the cavities. This is because, when it is tried to achieve close contact of the mold release film with the surface of each cavity and the runner portion by suction, the mold release film in close contact with the cavity surface would be pulled toward the runner portion by such suction applied in the runner portion. Consequently, the mold release film in close contact with the cavity surface would move toward the runner portion, thereby causing wrinkles in the film. The film would readily wrinkle since the cavities are provided independently for the respective chips.

In other words, with a conventional mold assembly having a two-piece structure of upper and lower molds, it is very difficult to ensure close contact of the mold release film with the molding surface.

Further, when a mold assembly of such a two-piece structure is used, it is very difficult to employ the molding using the mold release film in combination with vacuum molding for preventing formation of voids in a resin material or the like.

Meanwhile, according to a method in which a mold assembly having one cavity provided for a plurality of chips, rather than cavities provided for the respective chips, is used, and in which resin molding is carried out collectively for a plurality of chips in one cavity, it would not be possible to solve the problem of warpage of the finished, sealed substrate (product).

### SUMMARY OF THE INVENTION

An object of the present invention is to provide a resin sealing and molding method of an electronic component that can reliably bring a mold release film into close contact with a molding surface (at least a cavity surface) along the shape of the surface, and that can also solve the problem of warpage of the finished, sealed substrate. According to the method of the present invention, it is possible to efficiently perform resin sealing and molding of a substrate on which a large number of thin and small chips (electronic components) are mounted.

A resin sealing and molding method of an electronic component according to the present invention includes the steps of: preparing an upper mold, a lower mold opposite to the upper mold, an intermediate mold provided between the upper and lower molds, and a mold release film covering a cavity of the lower mold; attaching a substrate mounted with the electronic component to the upper mold; applying the mold release film to at least a lower mold cavity surface constituting a part of an entire surface of the cavity in the state where the mold release film is pinched and held between the intermediate mold and a pinching member provided at the lower mold; and closing the upper mold, the intermediate mold and the lower mold to immerse the electronic component in molten resin within the cavity covered with the mold release film. In the step of applying the mold release film, the mold release film is forcibly attracted toward at least the lower mold cavity surface, so that the mold release film covers the entire surface of the cavity in a state of tension along a shape of the entire surface of the cavity, the entire surface of the cavity including, in addition to the lower mold cavity surface, a cavity surface made of a cavity side surface formed on an outer periphery of the lower mold cavity surface, a cavity partition surface partitioning the lower mold cavity surface into a plurality of blocks, and a communication path surface causing the blocks to communicate with each other. Further in this state, the molten resin within the cavity flows through a communication path to be distributed uniformly into each of the blocks, and the molten resin cures in the state where the electronic component is immersed in the molten resin, so that the electronic component is sealed and molded with the cured resin.

Preferably, the resin sealing and molding method of an electronic component according to the present invention further includes the step of blocking a gap between the upper mold and the intermediate mold with a seal member for blocking an outside air to form a space blocked off from the outside air, and evacuating the space to a vacuum.

According to the present invention, it is possible to efficiently seal a matrix-type substrate mounted with an electronic component with resin, and thus to improve productivity of the sealed substrate (product) by achieving maximum benefits of automatic control of the resin sealing process.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view of a substrate subjected to sealing and molding in a mold assembly for resin sealing and molding an electronic component according to the present invention, wherein a substrate to be sealed and a sealed substrate are shown in the right and the left, respectively.

FIG. 2 is a schematic cross sectional view of the mold assembly for resin sealing and molding the substrate corresponding to FIG. 1, showing an open state of the mold assembly.

FIG. 3 is a schematic enlarged cross sectional view of a main part of the mold assembly corresponding to FIG. 2, showing a pinched and held state of a mold release film.

FIG. 4 is a schematic enlarged cross sectional view of the main part of the mold assembly corresponding to FIG. 2, showing an attracted state of the mold release film.

FIG. 5 is a schematic enlarged cross sectional view of the main part of the mold assembly corresponding to FIG. 2, showing the state where the mold release film is applied and secured in a state of tension.

FIG. 6 is a schematic perspective view of the mold assembly corresponding to FIG. 5.

FIG. 7 is a schematic cross sectional view of the main part of the mold assembly corresponding to FIG. 2, showing the substrate corresponding to FIG. 1 and a supplied state of a resin material.

FIG. 8 is a schematic perspective view of the mold assembly corresponding to FIG. 6, showing the supplied state of the resin material.

FIG. 9 is a schematic perspective view of a mold assembly different from that of FIG. 6, showing the state where a mold release film is applied and secured in a state of tension.

FIG. 10 is a schematic cross sectional view of the mold assembly corresponding to FIG. 2, showing a state of vacuuming.

FIG. 11 is a schematic cross sectional view of the mold assembly corresponding to FIG. 2, showing a clamped state of the substrate corresponding to FIG. 1.

FIG. 12 is a schematic cross sectional view of the mold assembly corresponding to FIG. 2, showing a full mold clamping state of the mold assembly.

### DESCRIPTION OF THE PREFERRED EMBODIMENTS

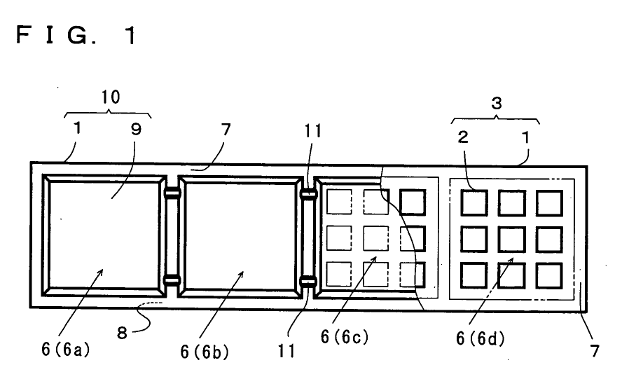

Hereinafter, a resin sealing and molding method according to an embodiment of the present invention will be described with reference to FIGS. 1-12.

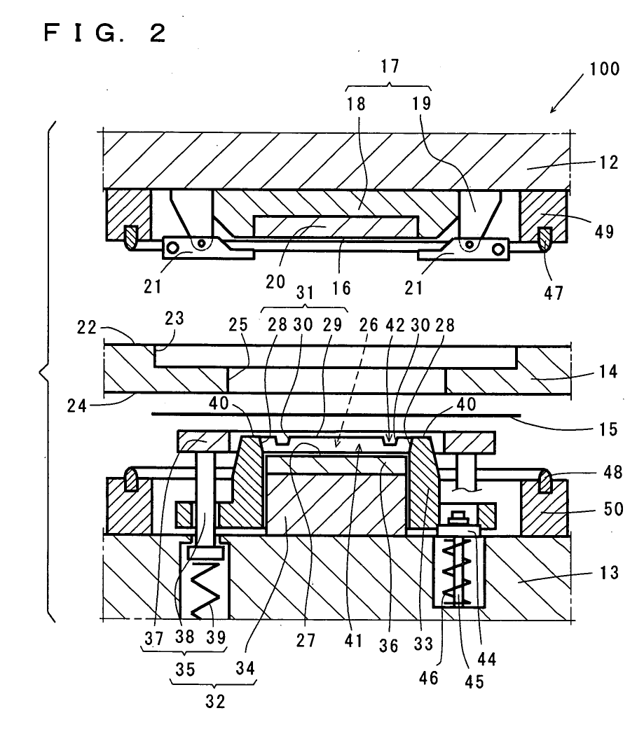

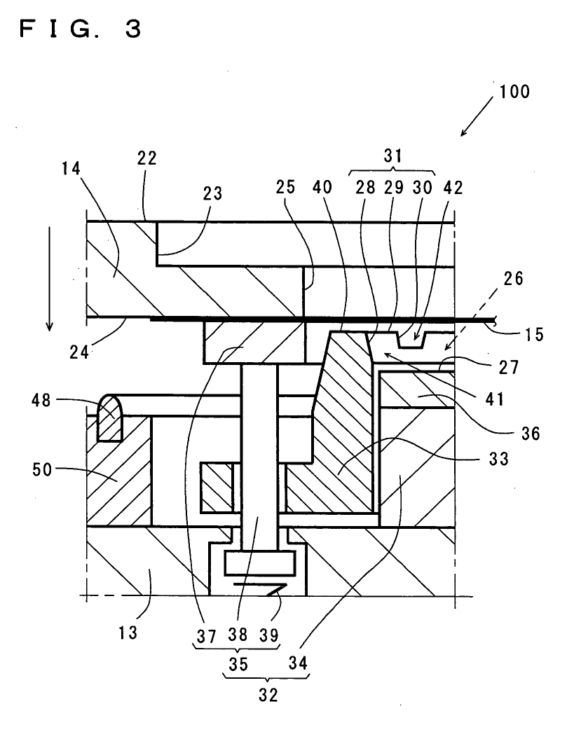

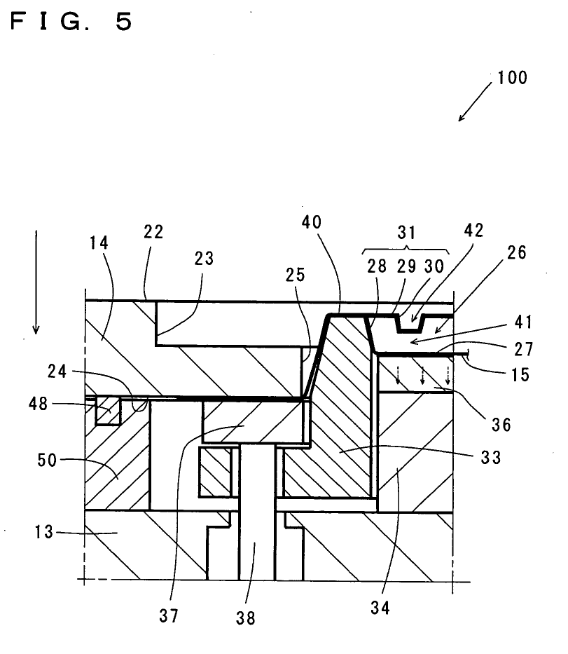

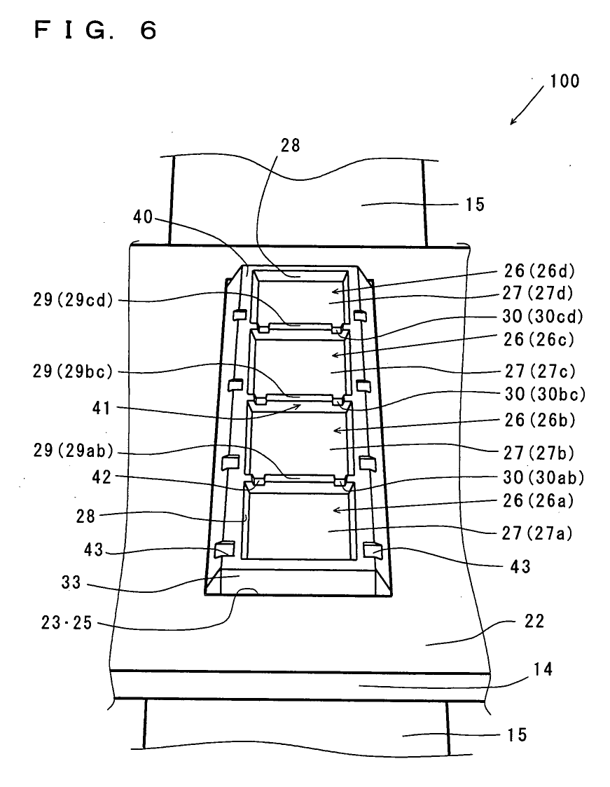

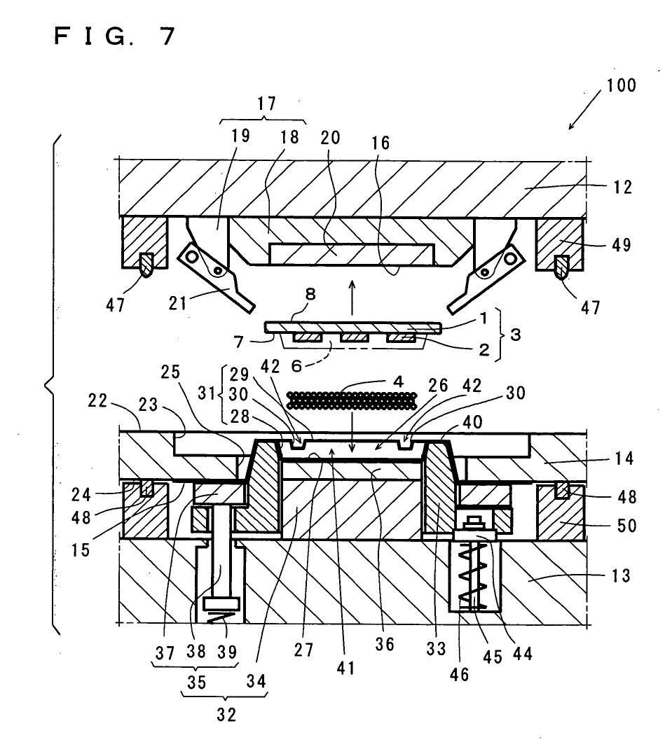

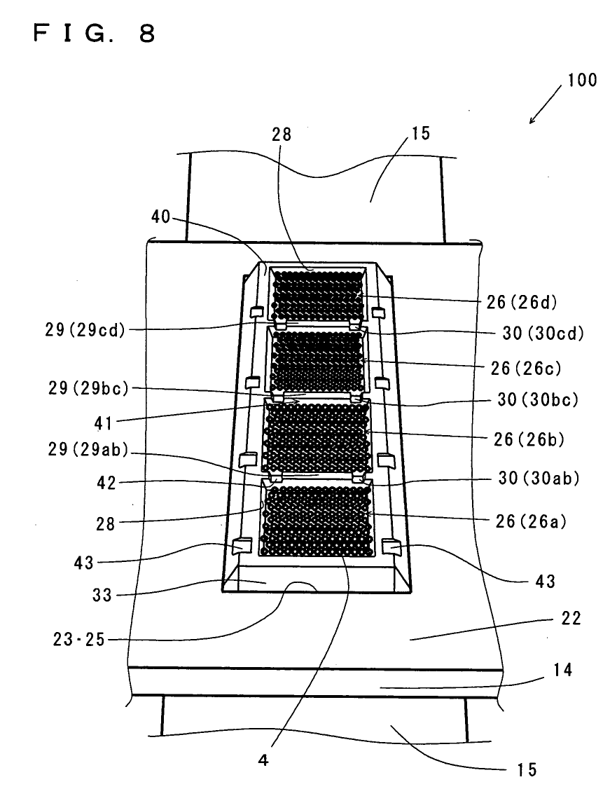

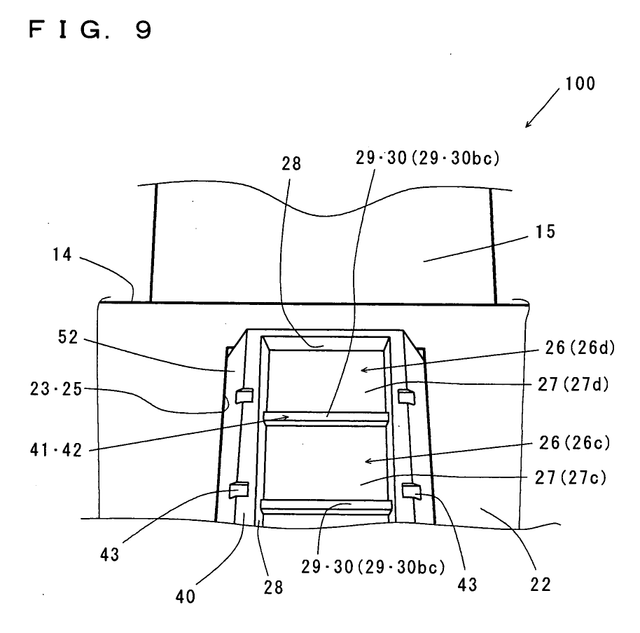

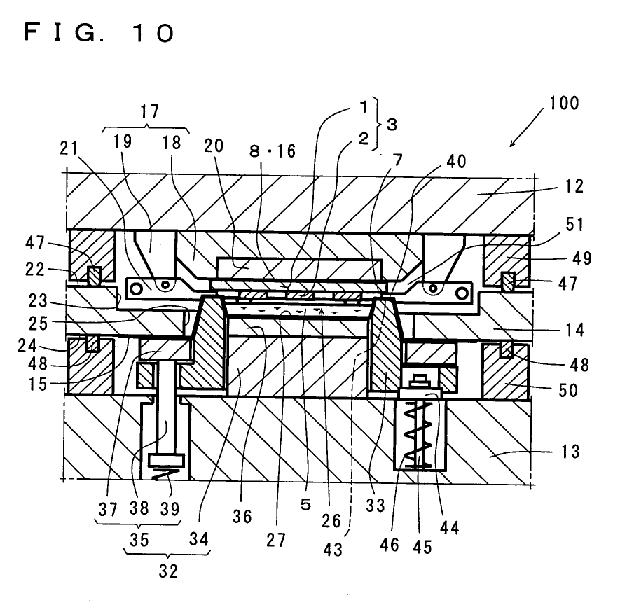

FIG. 1 is a schematic plan view of a matrix-type substrate to be sealed and molded by a resin sealing and molding method of an electronic component according to the present invention. FIG. 2 is a schematic cross sectional view of a main part of a mold assembly for resin sealing and molding that is used for resin sealing and molding the substrate corresponding to FIG. 1. FIGS. 3-5 are schematic enlarged cross sectional views of the main part of the mold assembly corresponding to FIG. 2. FIG. 6 is a schematic perspective view corresponding to FIG. 5. FIG. 7 is a schematic cross sectional view of the mold assembly corresponding to FIG. 2, showing the substrate and a supplied state of a resin material. FIG. 8 is a schematic perspective view showing the state after the resin material is supplied to the mold assembly corresponding to FIG. 7. FIG. 9 is a schematic enlarged perspective view of a main part of another mold assembly corresponding to FIG. 6. FIGS. 10-12 are schematic cross sectional views of the mold assembly corresponding to FIG. 2, showing a state sealed with resin in steps.

The respective figures for use in conjunction with the following explanation have portions omitted as appropriate or schematically shown with exaggeration, to facilitate understanding.

A matrix-type substrate 1, shown in FIG. 1, has a plurality of chips 2 (electronic components) mounted on one main surface thereof (see the right portion of the figure). Substrate 1 is formed in a circular shape, a polygonal shape or the like (rectangular shape in this case), although it may be in any shape. In the present embodiment, matrix-type substrate 1 changes from a substrate to be sealed 3 to a sealed substrate 10. Substrate to be sealed 3 has a sealing and molding portion 6, a substrate outer peripheral portion 7, and a non-mounting surface 8. Sealing and molding portion 6 is a portion provided on the one main surface where chips 2 are sealed and molded with a resin material 4 molten by heating (molten resin 5). Substrate outer peripheral portion 7 is a portion on the outer periphery of sealing and molding portion 6 on the one main surface where sealing and molding are not carried out. Non-mounting surface 8 is a surface on which the electronic components (chips 2) are not mounted, which corresponds to the other main surface opposite to the one main surface on which the electronic components are mounted. After sealing and molding, cured resin 9 is formed at sealing and molding portion 6, whereby sealed substrate 10 (product) is obtained (see the left portion of the figure).

In the present embodiment, four sealing and molding portions 6 are provided at sealed substrate 10, and nine chips 2 are arranged in a matrix in each of the four cured sealing and molding portions 6. Further, cured resin 11 is formed between the neighboring sealing and molding portions 6 to connect them with each other.

More specifically, sealing and molding portion 6 is divided into four blocks (6a, 6b, 6c, 6d), and cured resin 11 is formed in a communication path, between sealing and molding portions 6. In this manner, the conventional problem of deformation of the substrate (warpage, bow) can efficiently be solved.

For matrix-type substrate 1, a wire boding substrate, a flip chip substrate, or a wafer level package such as a wafer substrate, may be used.

For the material of substrate 1, any metal lead frame or a print circuit board, called PC board, made of plastic, ceramic, glass, or any other material may be used.

For resin material 4 for use in sealing and molding matrix-type substrate 1, any of tablet resin, liquid resin, granular resin, powder resin, sheet resin, or fine-grain resin having a grain size smaller than that of the granular resin and greater than that of the powder resin may be used.

A mold assembly 100 of the present embodiment will now be described in detail with reference to FIGS. 2-12. As shown in FIGS. 2-12, mold assembly 100 is provided with an upper mold 12, a lower mold 13 arranged opposite to upper mold 12, and an intermediate mold 14 arranged between upper mold 12 and lower mold 13. That is, mold assembly 100 of the present embodiment has a so-called three-piece structure (of 12, 13, 14), rather than the two-piece structure. Further, in mold assembly 100, a mold release film 15 is used. According to the resin sealing and molding method of the present embodiment, substrate to be sealed 3 shown in FIG. 1 is processed into sealed substrate 10.

As shown in FIGS. 2 and 7, upper mold 12 is provided with a substrate securing mechanism 17 on which substrate to be sealed 3 is mounted. Substrate securing mechanism 17 pinches and holds substrate 1 in a state where chips 2 on substrate to be sealed 3 are facing down, and secures the substrate 1 in a prescribed position (a substrate mounting surface 16) of the mold surface of upper mold 12.

Substrate securing mechanism 17 has a combination structure of a substrate attracting and securing portion 18 for attracting substrate 1 (substrate to be sealed 3, sealed substrate 10), and a substrate pinching and securing portion 19 for pinching and holding substrate 1. This configuration is used for the purpose of more efficiently securing substrate 1 to substrate mounting surface 16 in response to reduction in thickness of substrate 1 in recent years.

Substrate attracting and securing portion 18 has an air-permeable member 20 for substrate that attracts non-mounting surface 8 of substrate 1, and a vacuum mechanism (not shown) for evacuating a space within a cavity 26 to a vacuum. Air-permeable member 20 for substrate is made of an air-permeable and heat-resistant material such as metal, ceramic or the like. The vacuum mechanism is arranged at the upper surface of air-permeable member 20 opposite to its lower surface (substrate mounting surface 16), and evacuates the air, water, gas and the like from the space within the cavity to the outside via air-permeable member 20 and a path and a tube in communication with air-permeable member 20, by forcible suction.

In other words, non-mounting surface 8 of matrix-type substrate 1 is attracted and secured to the prescribed position (substrate mounting surface 16) of the lower surface of air-permeable member 20 for substrate, by forcible suction of substrate attracting and securing portion 18.

Further, approximately at the same time as substrate pinching and securing portion 19 releases sealed substrate 10, the air is blown to sealed substrate 10 via the above-described air-permeable member 20 and the path and the tube in communication with air-permeable member 20. This further ensures that non-mounting surface 8 of sealed substrate 10 is detached from the prescribed position (substrate mounting surface 16) of the mold surface of upper mold 12.

Substrate pinching and securing portion 19 is provided with a plurality of (in this case, eight) chuck nails 21 in the periphery of substrate attracting and securing portion 18 to support substrate outer peripheral portion 7.

Chuck nails 21 normally extend in an approximately horizontal direction for standby in a state not in contact with substrate mounting surface 16. At the time when substrate 1 (3, 10) is detached from or attached to substrate securing mechanism 17, a tip end of each chuck nail 21 pivots about the hinge portion of chuck nail 21 as a supporting point. As such, chuck nail 21 changes from the state (closed state) extending approximately in parallel with substrate mounting surface 16 to the state (open state) extending diagonally downward and inward.

More specifically, substrate securing mechanism 17 uses both the attracting and securing system of substrate attracting and securing portion 18 and the pinching and securing system of substrate pinching and securing portion 19, to mount and secure a variety of substrates 1 to a prescribed position (substrate mounting surface 16) of the mold surface of upper mold 12 in a reliable manner, as shown in FIG. 10. This ensures that substrate 1 is secured to upper mold 12, without being shifted downward or in a horizontal direction.

Intermediate mold 14 has an upper housing portion 23 having an opening at its mold surface facing upper mold 12 (an upper mold side mold surface 22), and a lower housing portion 25 having an opening at its mold surface facing lower mold 13 (a lower mold side mold surface 24). Upper and lower housing portions 23, 25 communicate with each other, and penetrate through intermediate mold 14 in the vertical direction.

At the time of mold closing of upper mold 12 and intermediate mold 14, at least chuck nails 21 of substrate securing mechanism 17 are received in upper and lower housing portions 23, 25 in such a manner that they do not contact intermediate mold 14. Further, at least cavity 26 portion of lower mold 13 penetrates through lower housing portion 25 to reach upper housing portion 23.

Further, at the time of mold opening of mold assembly 100 as shown in FIG. 2, mold release film 15 is inserted between lower mold side mold surface 24 of intermediate mold 14 and the upper surface of lower mold 13 in a state applied with tension.

As shown in FIG. 6, lower mold 13 has four cavities 26 corresponding to four sealing and molding portions 6 (cured resin 9) of substrate 1. It is noted that the number of sealing and molding portions 6 and corresponding cavities 26 is not limited to four; it may be any value as long as the object of the present invention can be achieved.

Cavities 26 (26a, 26b, 26c, 26d) are formed corresponding to sealing and molding portions 6 (6a, 6b, 6c, 6d) of matrix-type substrate 1 shown in FIG. 1.

More specifically, lower mold cavity surfaces 27 (27a, 27b, 27c, 27d) are formed at prescribed positions of lower mold 13 corresponding to the upper surfaces of sealing and molding portions 6 (6a, 6b, 6c, 6d), respectively, as shown in FIG. 6.

Further, as shown in FIGS. 2 and 6, cavity 26 has a cavity surface 31 in addition to lower mold cavity surface 27. Cavity surface 31 has a cavity side surface 28 that is formed at the outer periphery of lower mold cavity surface 27, a cavity partition surface 29 (in this case, three partition surfaces 29ab, 29bc, 29cd) that partitions lower mold cavity surface 27 into a plurality of blocks (in this case, four blocks), and a communication path surface 30 (in this case, two for each partition surface 29, and hence, six communication path surfaces 30ab, 30bc, 30cd in total) that is provided at the upper surface of cavity partition surface 29 and constitutes a communication groove for causing the spaces in the blocks to communicate with each other.

Lower mold 13 has a film securing mechanism 32 for securing mold release film 15 at a prescribed position (lower mold cavity surface 27) of its mold surface while pinching and attracting the same, and a cavity member 33 including cavity surface 31 (cavity side surface 28, cavity partition surface 29, communication path surface 30) that constitutes cavity 26 together with lower mold cavity surface 27.

Film securing mechanism 32 has a film attracting and securing portion 34 that attracts mold release film 15, and also has a film pinching and securing portion 35 that pinches and holds mold release film 15. This configuration is used for the purpose of more efficiently bringing mold release film 15 into close contact with the molding surface, at least along the entire surface of cavity 26, in response to reduction in thickness of substrate 1 in recent years.

Film attracting and securing portion 34 has an air-permeable member 36 for film that is made of an air-permeable and heat-resistant material such as metal, ceramic or the like, which attracts mold release film 15 toward lower mold cavity surface 27, and a vacuum mechanism (not shown) provided at the lower surface of air-permeable member 36 opposite to its upper surface (lower mold cavity surface 27) and forcibly evacuating the air, water, gas and the like from a path in communication with air-permeable member 36 through a tube and a valve to the outside.

Thus, mold release film 15 is forcibly attracted by film attracting and securing portion 34, and comes into close contact with the prescribed position (at least lower mold cavity surface 27) at the upper surface of air-permeable member 36.

Further, in the resin sealing and molding apparatus of the present embodiment, mold opening is performed as only lower mold 13 moves downward. At this time, air-permeable member 36 or the like attracting mold release film 15 is used, and the air is blown from lower mold cavity surface 27 via mold release film 15 toward cured sealing and molding portion 6 (cured resin 9). This separates sealed substrate 10 from lower mold 13.

Film pinching and securing portion 35 is provided around film attracting and securing portion 34 in such a manner that it can be integrated with cavity member 33. Film pinching and securing portion 35 has a pinching member 37 that abuts against mold release film 15 and pinches and holds the same, a plurality of attachment bars 38 that push pinching member 37 up in the vertical direction, and a resilient member 39 made of a spring or the like that elastically supports pinching member 37 and attachment bars 38 in the vertical direction.

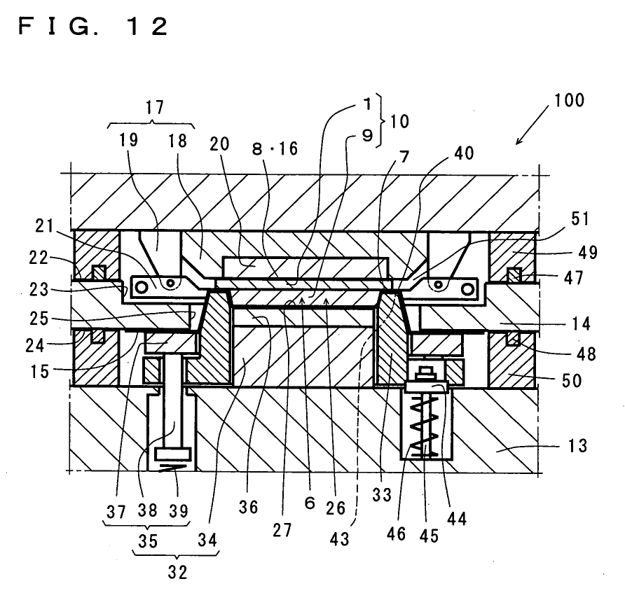

More specifically, at the time of mold opening as shown in FIG. 2, the upper surface of pinching member 37 is located upper than cavity member 33, with resilient member 39 in a restored (extended) state, for standby. Meanwhile, at the time when lower mold 13 and intermediate mold 14 are clamped, approximately at the same time as pinching member 37 and attachment bars 38 move downward, resilient member 39 starts contracting, and at the time of mold closing of mold assembly 100 as shown in FIG. 12, resilient member 39 attains the most contracted state.

Cavity member 33 is fitted around attracting and securing portion 34 of film securing mechanism 32, as shown in FIGS. 2 and 6. Further, cavity member 33 has a cross section of an L shape, with a vertical portion and a horizontal portion.

The vertical portion of cavity member 33 has the above-described cavity side surface 28, a substrate abutting site 40 that abuts against substrate outer peripheral portion 7 of matrix-type substrate 1 with mold release film 15 interposed therebetween, a plurality of (in this case, three) partition portions 41 having cavity partition surfaces 29 dividing communication path surface 30 and lower mold cavity surface 27 into a plurality of blocks, a communication path 42 for adjustment of the amount of resin (in this case, two paths for one partition portion 41) provided on the upper surface of each partition portion 41 and for uniformly distributing molten resin 5 to the plurality of blocks, and a chuck nail housing portion 43 that houses a tip end portion of chuck nail 21 at the time of mold closing of mold assembly 100 such that it would not contact substrate abutting site 40 and cause damage or crack thereto.

More specifically, in cavity member 33 shown in FIG. 6, the vertical portion of the L shape of cavity member 33 and each partition portion 41 are formed integrally such that substrate abutting site 40, except for chuck nail housing portion 43, and cavity partition surface 29, except for communication path surface 30, are approximately flush with each other.

As another configuration of cavity member 33, it is conceivable to form each partition portion 41 integrally with lower mold cavity surface 27, but separate from the vertical portion of the L shape of cavity member 33, as shown in FIG. 9. In this case, communication path surface 30 is formed over the entire top of each partition surface 29 along the longitudinal direction thereof, and each partition surface 29 is located lower than substrate abutting site 40. In this case as well, it is of course possible to form communication path surface 30 (communication path 42) of cavity member 33 to have a configuration similar to that shown in FIG. 6, instead of forming communication path surface 30 all over the top of each partition surface 29 along its longitudinal direction.

Further, the horizontal portion of the L shape of cavity member 33 is rested on a resting member 44. Cavity member 33 and resting member 44 are attached to a tip end of an attachment member 45 that extends in the vertical direction. A resilient member 46 such as a spring or the like is provided to surround attachment member 45.

According to the resin sealing and molding apparatus of the present embodiment, in the mold open state as shown in FIG. 2, cavity surface 31 of cavity member 33 is set on standby in the position upper than lower mold cavity surface 27 and lower than the upper surface of pinching member 37, and resilient member 46 is set on standby in a restored (extended) state. Meanwhile, at the time of mold closing of mold assembly 100 as shown in FIG. 12, cavity member 33 abuts against the upper surface of lower mold 13, and resilient member 46 is in the most contracted state.

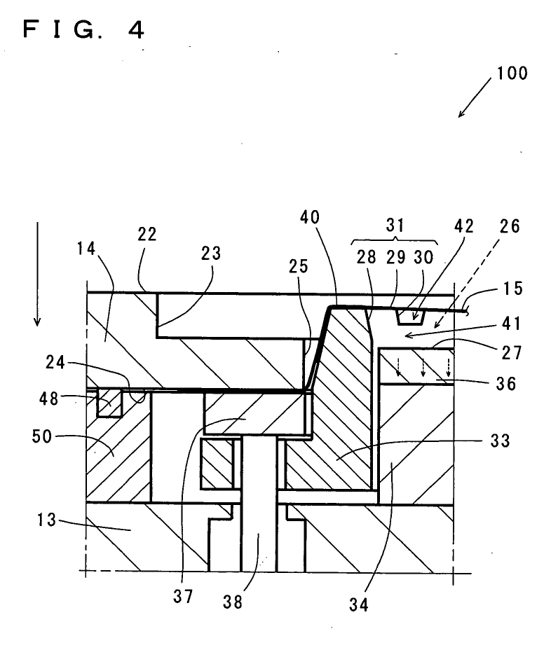

The resin sealing and molding apparatus of the present embodiment changes from the state where mold assembly 100 is open, as shown in FIG. 2, to the state where intermediate mold 14 and lower mold 13 are closed, as shown in FIGS. 3 and 4, at the time when lower mold cavity surface 27 is covered with mold release film 15. Thereafter, intermediate mold 14 and lower mold 13 are further closed, as shown in FIGS. 5 and 6, and mold release film 15 is pinched and held by film pinching and securing portion 35. Further, mold release film 15 is forcibly attracted by film attracting and securing portion 34 toward lower mold cavity surface 27. As a result, mold release film 15 covers the entire surface of cavity 26 in the state applied with tension, along the shape of the entire surface of cavity 26 including cavity side surface 28, cavity partition surface 29 and communication path surface 30 constituting cavity surface 31, in addition to lower mold cavity surface 27.

FIG. 7 shows the state immediately before resin material 4 (in this case, granular resin) is supplied into cavity 26 that is covered with mold release film 15, as shown in FIGS. 5 and 6. FIG. 8 shows the state after resin material 4 is supplied into each cavity 26.

In recent years, there is a demand to form sealing and molding portion 6 thinner, and hence, form cavity 26 thinner, as shown in FIG. 6. It is difficult to supply resin material 4 uniformly into cavity 26 thus reduced in thickness. It is more difficult to supply the resin material uniformly to a plurality of cavities 26 divided and provided corresponding to the plurality of chips.

According to the resin sealing and molding apparatus of the present embodiment, however, even if resin material 4 is not supplied uniformly into respective cavities 26 when the resin material is supplied thereto as shown in FIGS. 7 and 8, molten resin 5 will be distributed uniformly into the plurality of cavities 26 via communication path 42 covered with mold release film 15 in the state applied with tension, for example at the time of mold clamping where mold assembly 100 changes from the state as shown in FIG. 10 to the state as shown in FIG. 12.

As a prescribed time passes, molten resin 5 finally turns to cured resin 9, and substrate 1 (sealed substrate 10) as shown in FIG. 1 is formed.

That is, according to the resin sealing and molding method of the present embodiment, when resin sealing is performed on a substrate mounted with a large number of thin and small chips 2 (electronic components) using a mold assembly 100 of a three-piece structure, it is possible to reliably bring mold release film 15 into close contact with the molding surface (at least the entire surface of cavity 26) along the shape of the surface, and it is also possible to efficiently solve the problem of warpage of finished, sealed substrate 10.

Further, in the mold closing state, the space between the mold surface of upper mold 12 and the mold surface of lower mold 13 is blocked off by an upper seal member 47 that abuts against upper mold side mold surface 22 of intermediate mold 14 and a lower seal member 48 that abuts against lower mold side mold surface 24 of intermediate mold 14. These upper and lower seal members 47, 48 work together with the vacuum mechanism (not shown), to create a space of a vacuum state for resin molding of mold assembly 100 of the present embodiment.

Although seal members 47 and 48 are attached to upper mold 12 and lower mold 13, respectively, in mold assembly 100 of the present embodiment, mold assembly 100 provided only with upper seal member 47 may be used instead.

Upper and lower seal members 47 and 48 are each arranged at the position outer than substrate securing mechanism 17 and film securing mechanism 32, in a manner protruding from upper and lower seal securing portions 49 and 50, respectively.

For example, for upper and lower seal members 47 and 48, it is preferable to use a material excellent in elasticity, heat resistance and durability, such as a hollow seal, O ring and the like.

As a way of performing vacuuming of mold assembly 100, it is conceivable to use a method of moving the upper surface (upper mold side mold surface 22) of intermediate mold 14 upward to cause it to abut against upper seal member 47, as shown in FIG. 10. According to this method, upper seal member 47 is deformed or crushed as it is sandwiched between upper mold 12 and intermediate mold 14, and thus, cavity 26 is blocked off from the outside air, whereby an outside air-blocked space portion 51 is formed. Approximately at the same time, the air, water, gas and the like are evacuated from a path in communication with outside air-blocked space portion 51 via a tube and a valve, by forcible suction.

With the use of mold assembly 100 of the three-piece structure (12, 13, 14) and mold release film 15, together with the use of the vacuum molding, it is possible to seal chips 2 mounted on matrix-type substrate 1 with resin material 4 (molten resin 5) without formation of voids or the like.

Hereinafter, the resin sealing and molding method of the present embodiment using the above-described mold assembly 100 of the three-piece structure (12, 13, 14) and mold release film 15 in combination with the vacuum molding will be described in detail step by step.

Firstly, as shown in FIG. 2, in the state where upper mold 12, lower mold 13 and intermediate mold 14 are open, mold release film 15 is inserted between the top surface of pinching member 37 of film pinching and securing portion 35 and lower mold side mold surface 24 of intermediate mold 14, or, in the space between the upper surface of lower mold cavity surface 27 and the lower surface of intermediate mold 14, in the state applied with tension such that it will extend approximately in a horizontal direction. At this time, chuck nails 21 of substrate pinching and securing portion 19 of upper mold 12 are set on standby in an approximately horizontal state, i.e., in the closed state.

Next, as shown in FIG. 3, when intermediate mold 14 moves downward in the state where mold release film 15 abuts against lower mold side mold surface 24 of intermediate mold 14, intermediate mold 14 and pinching member 37 move downward together in the state where mold release film 15 is pinched and held between lower mold side mold surface 24 and the top surface of pinching member 37. At this time, with the movement of intermediate mold 14 and pinching member 37, attachment bars 38 of pinching and securing portion 35 also move downward, so that resilient member 39 is contracted.

Next, as shown in FIG. 4, approximately at the same time as the bottom surface of pinching member 37 comes to abut against the upper surface of the horizontal portion of cavity member 33, a portion of mold release film 15 inner than substrate abutting site 40 is forcibly attracted toward lower mold cavity surface 27 by attracting and securing portion 34 of film securing mechanism 32.

At this time, substrate abutting site 40 at the vertical portion of the L shape of cavity member 33 is received by upper and lower housing portions 23, 25 of intermediate mold 14, and thus, the portion of mold release film 15 inner than substrate abutting site 40 protrudes upward than the remaining portion. As a result, a large tension is imposed on the portion of mold release film 15 inner than substrate abutting site 40. At this time, mold release film 15 is in an extended state, since the entirety of mold assembly 100 is heated to melt resin material 4.

Next, in the closing state of the molds (13, 14) shown in FIG. 4, as the portion of mold release film 15 in the state of tension inner than substrate abutting site 40 is continuously attracted forcibly toward lower mold cavity surface 27, mold release film 15 covers the entire surface of cavity 26 in the state of tension along the shape of the entire surface (molding surface) of cavity 26 including lower mold cavity surface 27 and cavity surface 31 (cavity side surface 28, cavity partition surface 29, communication path surface 30), as shown in FIGS. 5 and 6. In this manner, a molding space for sealing sealing and molding portion 6 with resin is formed in cavity 26.

Next, as shown in FIG. 7, in the state where the molding space is formed in cavity 26, the preparing step for supplying resin material 4 into respective cavities 26 (blocks) divided by partition portion 41 in cavity member 33 individually and approximately at the same time, is carried out. At this time, upper mold 12 is set on standby with chuck nails 21 maintaining a prescribed state. More specifically, when substrate to be sealed 3 is supplied and set to upper mold 12, the upper mold 12 is set on standby, with chuck nails 21 of substrate pinching and securing portion 19 extending diagonally downward to face the mold surface of upper mold 12, such that chuck nails 21 would not collide with substrate 1.

Next, in the above-described state where the molding space is formed in cavity 26, resin material 4 is supplied into the molding spaces of the respective cavities 26 separately and approximately at the same time, as shown in FIG. 8.

At this time, although resin material 4 supplied is divided by each partition portion 41 of cavity member 33, at the time of mold clamping of mold assembly 100 as shown in FIGS. 10-12, which will be described later, resin material 4 turns to molten resin 5, which is distributed uniformly into the plurality of blocks through each communication path 42. Therefore, even if there is some variation in supply amount of resin material 4 among the molding spaces of the plurality of cavities 26 (the plurality of blocks), it would not cause the problem of variation in shape of the plurality of molded products.

Next, although not shown, the preparing step for mold clamping by causing molds 13, 14 to move upward together toward upper mold 12 is carried out. At this time, substrate outer peripheral portion 7 of substrate to be sealed 3 is pinched and held by chuck nails 21 and substrate attracting and securing portion 18, in the state where non-mounting surface 8 of substrate to be sealed 3 is attracted to a prescribed position (substrate mounting surface 16) of the mold surface of upper mold 12. This ensures that substrate to be sealed 3 is firmly secured to substrate securing mechanism 17. At this time, the entirety of mold assembly 100 is heated, and thus, resin material 4 supplied to the molding spaces of cavities 26 is heated to the extent that it is molten. As a result, resin material 4 is molten and turns to molten resin 5. Further, mold release film 15 covering the surface of cavity 26 in the state of tension is pressed against cavity surface 31 of cavity member 33 by the own weight of molten resin 5. This prevents generation of wrinkles of mold release film 15 more reliably. As a result, mold release film 15 is brought into close contact with the entire surface of cavity 26 along its shape. While mold release film 15 is attracted toward lower mold cavity surface 27 by attracting and securing portion 34 of film securing mechanism 32, with the own weight of molten resin 5, occurrence of film wrinkles is suppressed more reliably, and thus, mold release film 15 comes into close contact with lower mold cavity surface 27 along the shape of the surface.

The steps described so far in conjunction with FIGS. 3-8, i.e., the step of mounting and securing substrate to be sealed 3 onto the mold surface of upper mold 12, the step of forming the molding space of cavity 26, the step of preheating the entirety of mold assembly 100, and the step of supplying resin material 4 into the molding space of cavity 26, may be carried out in a different order, as long as those steps are carried out before a vacuuming step shown in FIG. 10 as described below.

Next, as shown in FIG. 10, in the state where molten resin 5 is supplied to the molding space formed in cavity 26, molds 13, 14 are moved upward together toward upper mold 12. As such, mold assembly 100 attains the intermediate mold closing state. That is, upper mold side mold surface 22 of intermediate mold 14 abuts against upper seal member 47 formed at the mold surface of upper mold 12, and thus, upper seal member 47 is deformed or crushed. In this manner, the molding space of cavity 26 is blocked off from the outside air, thus forming outside air-blocked space portion 51. Approximately at the same time, the air and the like is forcibly evacuated from the molding space to the outside via the path in communication with the vacuum mechanism.

Resin material 4 inside the molding space of cavity 26 does not have to turn to molten resin 5 in the above-described mold closing state; all that is needed is that it turns to molten resin 5 before completion of the vacuuming step.

Further, although the vacuuming step of mold assembly 100 of the present embodiment is carried out in the intermediate mold closing state (see FIG. 10), this step may be carried out intermittently by stopping movement of lower mold 13 and intermediate mold 14 a plurality of times, during the transition period from the above-described intermediate mold closing state to a full mold closing state (see FIG. 12). Furthermore, it may be carried out continuously, without stopping mold assembly 100, during the period from the position of the above-described intermediate mold closing state to the position of the full mold closing state, by reducing the mold closing speed (closing speed of mold assembly 100).

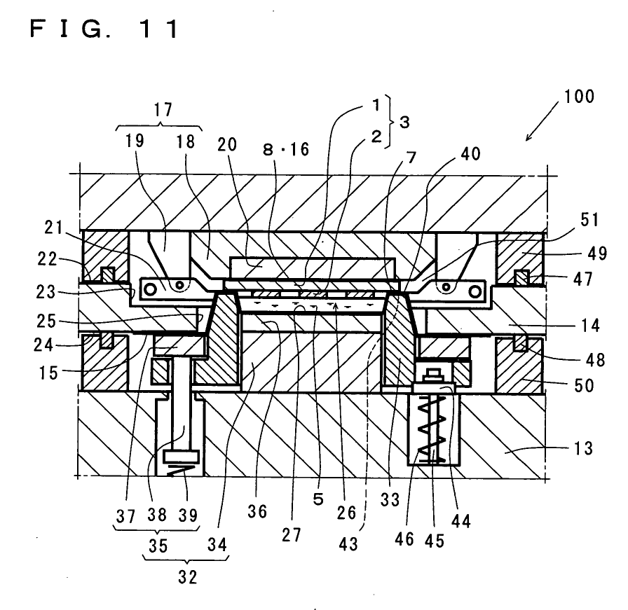

Next, as shown in FIG. 11, lower mold 13 and intermediate mold 14 are moved upward further toward upper mold 12. Thus, the mold surface of upper mold 12 comes into contact with upper mold side mold surface 22 of intermediate mold 14. Approximately at the same time, substrate abutting site 40 presses substrate outer peripheral portion 7 of substrate to be sealed 3, with mold release film 15 interposed therebetween.

At this time, the electronic components (chips 2) are partially immersed in molten resin 5 in the molding space of cavity 26. In the state where chuck nails 21 are holding substrate outer peripheral portion 7 of substrate to be sealed 3, chuck nails 21 are each received by upper housing portion 23 of intermediate mold 14 and chuck nail housing portion 43 of cavity member 33.

This ensures that substrate abutting site 40 presses the entirety of substrate outer peripheral portion 7 of substrate 1. Accordingly, in the full mold closing state of mold assembly 100 as shown in FIG. 12, leakage of molten resin 5 onto substrate 1 at substrate outer peripheral portion 7 is prevented even after chips 2 are completely immersed in molten resin 5.

In the present embodiment, upper mold side mold surface 22 of intermediate mold 14 is in contact with the mold surface of upper mold 12. Alternatively, resin sealing and molding may be carried out in the state where the mold surface of upper mold 12 is spaced apart from upper mold side mold surface 22, as long as upper seal member 47 is fully deformed or crushed and thus the molding space is blocked off from the outside air.

Further, the timing of finishing the vacuuming step may be any timing from the intermediate mold closing state (see FIG. 10) to the full mold closing state (see FIG. 12). Nevertheless, it is desirable that vacuuming is carried out continuously until resin sealing is completed in the full mold closing state of mold assembly 100 as shown in FIG. 12 and the vacuuming is terminated after completion of the resin sealing.

Next, when lower mold 13 alone is moved upward as shown in FIG. 12 from the state as shown in FIG. 11 where substrate to be sealed 3 is pressed against substrate attracting and securing portion 18 by substrate abutting site 40, the electronic components (chips 2) are fully immersed in molten resin 5. In this state, pinching member 37 and cavity member 33 are in contact with each other. Thus, with the upward movement of lower mold 13, the bottom surface of cavity member 33 abuts against the upper surface of lower mold 13. At this time, resilient members 39, 46 provided at lower mold 13 each attain the most contracted state. The state shown in FIG. 12 corresponds to the full mold closing state of mold assembly 100 (of three pieces 12, 13, 14).

In mold assembly 100 of the present embodiment, communication path 42 is provided so that the amount of resin becomes uniform in each of the plurality of blocks serving as the molding spaces of cavities 26. In addition to provision of communication path 42, it may be possible to change, e.g., the position in height of lower mold cavity surface 27 constituting the bottom surface of the molding space of cavity 26 in the vertical direction in the figure.

Further, a measurement device (not shown) such as a pressure sensor or the like for monitoring mold clamping pressure may be buried in film attracting and securing portion 34 of lower mold 13.

Next, after a lapse of the time required for molten resin 5 enclosing the electronic components (chips 2) therein to cure or set in the state where the full mold closing state of mold assembly 100 as shown in FIG. 12 is maintained, cured resin 9 enclosing chips 2 is formed, so that sealed substrate 10 (product) is finally obtained.

At this time, in substrate securing mechanism 17 and film securing mechanism 32, the air suctioning and exhausting operations are carried out continuously. Alternatively, one or both operations of substrate securing mechanism 17 and film securing mechanism 32 may be stopped temporarily.

Next, mold assembly 100 is changed from the state shown in FIG. 12 to the state shown in FIG. 11 so as to release finished, sealed substrate 10 from lower mold 13 and mold release film 15. At this time, although not shown, lower mold 13 (lower mold cavity surface 27) alone is moved downward for mold opening of lower mold 13 and intermediate mold 14. This creates a gap between mold release film 15 and lower mold cavity surface 27. Approximately at the same time, a pressure delivering mechanism provided at attracting and securing portion 34 of film securing mechanism 32 blows the air from lower mold cavity surface 27 toward sealed substrate 10, whereby sealed substrate 10 is released from lower mold cavity surface 27.

Next, although not shown, in the state where sealed substrate 10 is released from lower mold cavity surface 27, upper mold 12 on one hand and lower mold 13 and intermediate mold 14 on the other hand are opened. At this time, sealed substrate 10 is still mounted and secured to the prescribed position (substrate mounting surface 16) of the mold surface of upper mold 12.

Thereafter, lower mold 13 and intermediate mold 14 move downward together in the state where the shape of the molding space of cavity 26 is maintained.

Next, although not shown, in order to remove sealed substrate 10 from mold assembly 100, upper mold 12 and lower and intermediate molds 13 and 14 are further opened in a manner approximately the same as the state of mold assembly 100 shown in FIG. 7, and chuck nails 21 are opened to extend diagonally downward with respect to the mold surface of upper mold 12.

Substrate to be sealed 3 can be processed into sealed substrate 10 through a series of resin sealing steps described above in conjunction with FIGS. 2-12. It is needless to say that the series of resin sealing steps may be carried out continuously or intermittently.

According to the resin sealing and molding method of an electronic component of the present embodiment as described above, releasing efficiency between mold assembly 100 and resin material 4 (including highly dense resin material 4) as well as releasing efficiency between sealed substrate 10 and mold assembly 100 considerably increases, and occurrence of voids (bubbles) within resin material 4 can also be prevented. In other words, it is possible to enjoy both the benefits of the method using mold release film 15 and the benefits of the vacuum molding. Further, mold release film 15 can reliably be brought into close contact with the entire surface of cavity 26 corresponding to the shape of the molding surface (at least the entire surface of cavity 26), and at the same time, the problem of warpage of finished, sealed substrate 10 can be solved. As a result, it is possible to resin seal chips 2 efficiently, even in the case where matrix-type substrate 1 mounted with a great number of thin and small chips 2 is used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A resin sealing and molding method of an electronic component, comprising the steps of:
preparing an upper mold, a lower mold opposite to said upper mold, an intermediate mold provided between said upper and lower molds, and a mold release film covering a cavity of said lower mold;
attaching a substrate mounted with said electronic component to said upper mold;
applying said mold release film to at least a lower mold cavity surface constituting a part of an entire surface of said cavity in the state where said mold release film is pinched and held between said intermediate mold and a pinching member provided at said lower mold; and
closing said upper mold, said intermediate mold and said lower mold to immerse said electronic component in molten resin within the cavity covered with said mold release film;
wherein in said step of applying said mold release film, the mold release film is forcibly attracted toward at least said lower mold cavity surface, so that said mold release film covers the entire surface of said cavity in a state of tension along a shape of the entire surface of said cavity, the entire surface of said cavity including, in addition to said lower mold cavity surface, a cavity surface made of a cavity side surface formed on an outer periphery of said lower mold cavity surface, a cavity partition surface partitioning said lower mold cavity surface into a plurality of blocks, and a communication path surface causing said plurality of blocks to communicate with each other,
further in this state, the molten resin within said cavity flows through a communication path to be distributed uniformly into each of said blocks, and
said molten resin cures in the state where said electronic component is immersed in said molten resin, so that said electronic component is sealed and molded with the cured resin.

2. The resin sealing and molding method of an electronic component according to claim 1, further comprising the step of blocking a gap between said upper mold and said intermediate mold with a seal member for blocking an outside air to form a space blocked off from the outside air, and evacuating said space to a vacuum.
